(19) United States
(12) Patent Application Publication
(10) Pub. No.: US 2009/0190823 A1
(43) Pub. Date: Jul. 30, 2009

(54) IMAGING OF FINANCIAL DOCUMENTS STORED IN CARRIER ENVELOPES

(76) Inventor: Robert Walters, Northville, MI (US)

Correspondence Address: UNISYS CORPORATION, UNISYS WAY, MAIL STATION: E8-114, BLUE BELL, PA, 19424, US

(21) Appl. No.: 12/020,608

(22) Filed: Jan. 28, 2008

(51) Int. Cl. G06K 9/00

(52) U.S. Cl. 382/137

(57) ABSTRACT

In general, this disclosure describes techniques of efficiently generating digital versions of financial documents from physical versions of the financial documents. As described herein, one or more financial documents may be inserted into one or more pockets of an envelope. The envelope is sufficiently transparent to allow both sides the financial documents to be scanned with a digital image capture device. Furthermore, the envelope is sized in such that the envelope, with the financial documents, may be individually fed into the digital image capture device by an automatic document feeder that is capable of feeding individual pages having a standard paper size into the digital image capture device. After inserting the financial documents into the pockets of the envelope, digital images of the financial documents may be captured. The digital images of the financial documents may then be processed and transmitted to a financial institution.

### TECHNICAL FIELD

The invention relates to electronic processing of financial documents.

### BACKGROUND

When an individual or a business receives a physical financial document, such as a check, the individual or business may create a digital version of the financial document. In the case of a check, the digital version of the check may comprise a digital image of the check that conforms to certain standards along with appropriate metadata. Under the laws of the United States of America and other countries, the digital version of the financial document may be stored, redeemed, and otherwise used in the same manner as the physical financial document.

In many circumstances, financial institutions allow individuals and businesses to submit digital versions of financial documents received from other parties. Moreover, in many of these circumstances, financial institutions prohibit individuals and businesses from submitting physical versions of financial documents received from other parties. Financial institutions may prohibit individuals and businesses from submitting physical versions of financial documents because it may be more costly and time consuming to process physical versions of financial documents than equivalent digital versions of the financial documents.

In circumstances where financial institutions prohibit individuals and businesses from submitting physical copies of financial documents, individuals and businesses may be responsible for generating digital versions of the financial documents prior to submission of the financial documents to the financial institutions.

### SUMMARY

In general, this disclosure describes techniques of efficiently generating digital versions of financial documents from physical versions of the financial documents. As described herein, one or more financial documents can be inserted into one or more pockets of an envelope. The envelope is sufficiently transparent to allow both sides the financial documents to be scanned with a digital image capture device. Furthermore, the envelope is sized in such that the envelope, with the financial documents, can be individually fed into the digital image capture device by an automatic document feeder that is capable of feeding individual pages having a standard paper size into the digital image capture device. After inserting the financial documents into the pockets of the envelope, digital images of the financial documents may be captured. The digital images of the financial documents can then be processed and transmitted to a financial institution.

In one example, a method comprises positioning an envelope in a part of an image capture device such that no further manipulation of the envelope by a human is required in order to capture a digital image of financial documents stored in the envelope. The envelope comprises one or more front surface members and one or more rear surface members that are connected to each other such that the front surface members and the rear surface members define one or more pockets that are sized to store one of the financial documents securely. The envelope is sized such that an automatic document feeding device that is capable of automatically feeding individual pages of a standard paper size through an image capture area of an image capture device is capable of automatically feeding the envelope through the image capture area of the image capture device. The one or more front surface members of the envelope and the one or more rear surface members of the envelope are sufficiently transparent to enable an image capture device to optically capture digital images of a front surface and a rear surface of each of the financial documents stored in the envelope. The method also comprises generating digital images of a front surface and a rear surface of each of the financial documents that are stored in the envelope. In addition, the method comprises electronically transmitting digital versions of the financial documents to one or more financial institutions. Each of the digital versions of the financial documents include the digital images of the front surface of the financial document and the digital image of the rear surface of the financial document.

In another example, a system comprises an image capture device that receives an envelope in a part of the image capture device such that no further manipulation of the envelope by a human is required in order to capture a digital image of financial documents stored in the envelope. The envelope comprises one or more front surface members and one or more rear surface members that are connected to each other such that the front surface members and the rear surface members define one or more pockets that are sized to store one of the financial documents securely. The envelope is sized such that an automatic document feeding device that is capable of automatically feeding individual pages of a standard paper size through the image capture area of the image capture device is capable of automatically feeding the envelope through the image, capture area of the image capture device. The one or more front surface members of the envelope and the one or more rear surface members of the envelope are sufficiently transparent to enable the image capture device to optically capture digital images of a front surface and a rear surface of each of the financial documents stored in the envelope. The system also comprises a processing device that generates digital images of a front surface and a rear surface of each of the financial documents that are stored in the envelope. The processing device comprises an transmission module that electronically transmits digital versions of the financial documents to one or more financial institutions, wherein each of the digital versions of the financial documents include the digital images of the front surface of the financial document and the digital image of the rear surface of the financial document.

The details of one or more embodiments of the invention are set forth in the accompanying drawings and the description below. Other features, objects, and advantages of the invention will be apparent from the description, drawings, and claims.

### BRIEF DESCRIPTION OF THE DRAWINGS

FIG. 1 is a block diagram illustrating an example system that performs a check processing operation.

FIG. 2 is a flowchart illustrating an example operation of the system to submit digital versions of checks stored in a check carrier envelope to a financial institution.

FIG. 3 is a block diagram illustrating example details of a processing device.

FIG. 4 is a flowchart illustrating an example operation of the processing device.

FIG. 5 is an illustration of an example check carrier envelope.

FIG. 6 is an illustration of an example alternate check carrier envelope.

FIG. 7 illustrates how checks may be inserted into a check carrier envelope.

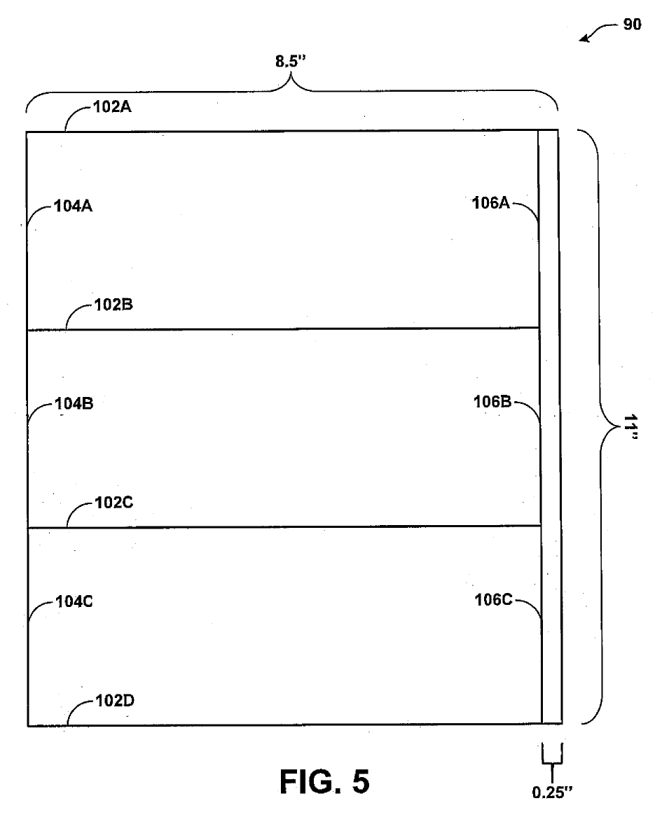

FIG. 5 illustrates how a front side of the check carrier envelope may appear when the check carrier envelope is storing checks.

FIG. 9 illustrates how a rear side of the check carrier envelope may appear when the check carrier envelope is storing checks.

FIG. 10 illustrates how one of the checks may be skewed within one of the pockets of the check carrier envelope.

### DETAILED DESCRIPTION

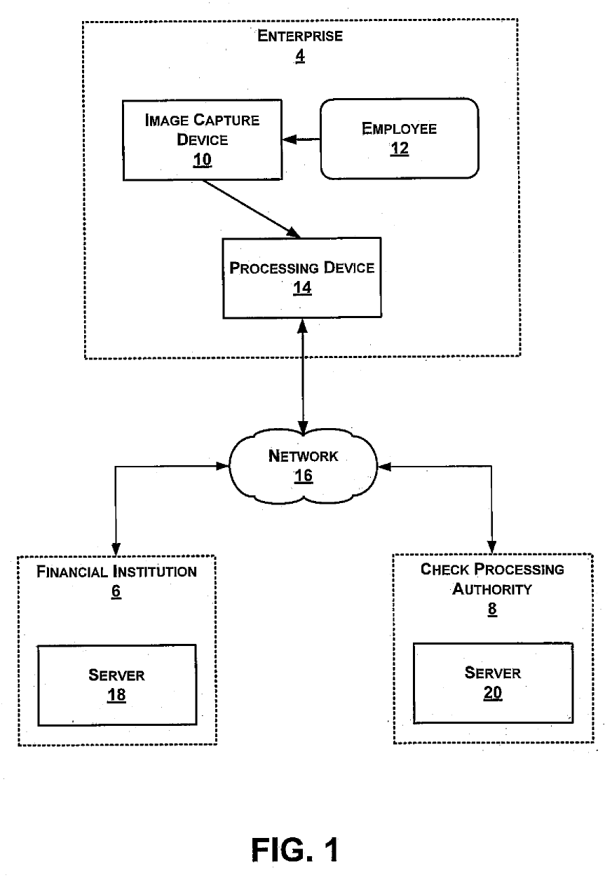

FIG. 1 is a block diagram illustrating an example system 2 that performs a check processing operation. It should be appreciated that FIG. 1 is provided for explanatory purposes and that the principles and techniques of this invention, as defined in the claims section of this disclosure, are not necessarily limited to the principles and techniques described in the example of FIG. 1.

As described in this disclosure, an employee may insert paper checks into a clear check carrier envelope that is designed to securely accommodate checks. After inserting the checks into the check carrier envelope, the employee may insert the check carrier envelope into a conventional office scanning device, such as a multifunction printer. Because the check carrier envelope is clear, the office scanning device can capture digital images of the checks while the checks are in the check carrier envelope. Image processing software may then be applied to automatically generate digital versions of the checks that can be sent to financial institutions. This system may be advantageous because it does not require any specialized equipment to capture digital images of checks.

As illustrated in the example of FIG. 1, system 2 includes an enterprise 4, a financial institution 6, and a check processing authority 8. Enterprise 4 may be a business entity (e.g., a corporation, partnership, limited partnership, sole proprietorship, limited liability company, etc.), a non-profit entity (e.g., a charity, a university, a school, a non-governmental organization, etc.), a governmental entity (e.g., a governmental bureau, office, agency, service, tax collection authority, etc.), or another type of public or private enterprise. Furthermore, although the example of FIG. 1 is explained with regard to enterprise 4, an individual acting in a private capacity may practice the principles and techniques of this invention in place of enterprise 4.

Enterprise 4 may receive checks from other parties. As used in this disclosure, a “check” is a draft, payable on demand and drawn on or payable through or at an office of a bank, whether or not negotiable, that is handled for forward collection or return. For example, a check may be a personal check, a traveler's check, a business check, a payroll check, a bearer check, a counter check, a money order, or another type of check.

Enterprise 4 may receive checks from other parties for a variety of reasons. For example, enterprise 4 may receive checks from other parties in exchange for goods and services provided by enterprise 4. In a second example, enterprise 4 may receive a check from another party for processing on behalf of the other party. In a third example, enterprise 4 may receive checks as donations.

In the example of FIG. 1, enterprise 4 must submit the checks to financial institution 6 in order to receive funds indicated by the received checks. Financial institution 6 may be a banking institution, a savings and loan association, a credit union, a mutual savings bank, a building society, or another type of financial institution. When enterprise 4 submits a check to financial institution 6, financial institution 6 may provide the check to a check processing authority 8. Check processing authority 8 may be a public or private entity that coordinates check processing between financial institutions. For example, in the United States of America, check processing authority 8, may be the Federal Reserve System. When check processing authority 8 receives a check from financial institution 6, check processing authority 8 may draw funds from a financial institution named by the check and transfer those funds to an account held by financial institution 6 for enterprise 4. After the funds are transferred to the account (i.e., after the check “clears”), enterprise 4 may have free access to the funds.

Depending on the terms of an agreement between enterprise 4 and financial institution 6, financial institution 6 may require enterprise 4 to submit digital versions of checks rather than physical versions of checks. As used in this disclosure, a “digital version of a check” is a set of digital information that comprises a digital image of the front side of the check, a digital image of the reverse side of the check, and appropriate metadata that describes the check. For instance, in the context of the American Check Clearing for the 211 Century Act (“Check 21 Act”), “truncated checks” are “digital versions of checks.”

The format of digital versions of checks may be controlled by governmental regulation, industry standards, or other voluntary or mandatory rules. For example, in the United States, the (Check 21 Act does not mandate a specific image quality level for digital images of an original check in a “truncated check”, but does mandate that substitute checks produced from images of original checks have sufficient quality to be used as the original check. In another example, in the United States, the Check 21 Act mandates that “truncated checks” include metadata that specifies the Magnetic Ink Character Recognition (MICR) field of the original check. The MICR field of a check may be the portion of the check that specifies a bank routing number, an account number, and possibly a check number. In the United States, the MICR fields of checks are formatted in the E13B character font.

In order to capture digital images of checks for the purpose of generating digital versions of the checks, enterprise 4 may include an image capture device 10 that is capable of capturing digital images. Image capture device 10 may be a wide variety of different types of devices, including devices that are not specialized to the purpose of capturing digital images of checks. For example, image capture device 10 may be a multifunction printer, a fax machine, a photocopier, a flatbed scanner, a drum scanner, a handheld scanner, a planetary scanner, a digital camera, or another type of image capture device. Example multifunction printers include MFC-7820N multifunction printers manufactured by Brother International of Nagoya, Japan, LaserJet™ M5925 MFP series multifunction printers manufactured by Hewlett-Packard Company of Palo Alto, Calif., and other types of multifunction printers. Furthermore, in the example in which image capture device 10 is a multifunction printer, employees of enterprise 4 may use the multifunction printer for everyday printing, scanning, copying, and/or faxing. Similarly, in the example in which image capture device 10 is a fax machine, employees of enterprise 4 may use the fax machine for everyday faxing.

Image capture device 10 may or may not include an automatic document feeder. An automatic document feeder is a mechanism that takes several pages and individually feeds the pages through an image capture area of an image capture device. An image capture area of an image capture device is a location at which the image capture device is capable of capturing a digital image of a document. Accordingly, all automatic document feeder may allow the user to scan multiple-page documents without having to manually replace each page.

In order to use image capture device 10 to capture digital images of checks received by enterprise 4, an employee 12 of enterprise 4 may insert individual ones of the checks into individual pockets in a check carrier envelope. In other words, employee 12 may insert a single separate check into each pocket of the check carrier envelope. The pockets of the check carrier envelope are sized to store checks securely. Furthermore, the check carrier envelope is sufficiently transparent to enable image capture device 10 to optically capture digital images of checks inserted into the pockets of the check carrier envelope. For example, the check carrier envelope may be constructed from a clear material (e.g., plastic). The check carrier envelope has a size such that when the check carrier envelope is loaded with checks having a standard paper weight, the check carrier envelope is capable of being automatically fed into an image capture area of an image capture device by an automatic document feeder that is designed to automatically feed individual paper pages of standard paper sizes into the image capture area of the image capture device. For example, the check carrier envelope may have the dimensions substantially equal to the dimensions of a standard paper size. Common standard paper sizes include letter (8.5 inches by 11 inches), A4, legal, and other paper sizes. In accordance with American National Standards Institute (ANSI) standards, the paper weights for checks may range from 20 to 24 pounds. Because the check carrier envelope has this size, a device that is used for everyday office imaging (e.g., a multifunction printer, copier, fax machine, etc.) can generate a digital image of the front surfaces of the checks in the check carrier envelope and a digital image of the rear surfaces of the checks in the check carrier envelope in a manner that the device would generate digital images of ordinary documents.

The check carrier envelope may be constructed in a variety of ways. For example, the check carrier envelope may comprise one or more front surface members and one or more rear surface members. The one or more front surface members and the one or more rear surface members may be connected to each other such that the one or more front surface members and the one or more rear surface members define one or more pockets. In this example, the front surface members and the rear surface members may be pieces of plastic that were originally separate, but were then bonded together to form the check carrier envelope described above. Alternatively, in this example, a front surface member and a rear surface member may have been a single piece of plastic that has been folded and then bonded to form the check carrier envelope described above. The front surface member and the rear surface member may be connected in a variety of ways. For instance, the front surface member and the rear surface member may be connected with adhesive bonds, chemical bonds, magnetic bonds, hook-and-loop fasteners, and/or other types of appropriate connection methods. Various example types of check carrier envelopes are described with regard to other figures in this disclosure.

In the example of FIG. 1, after employee 12 inserts the checks into the check carrier envelope, employee 12 may position the check carrier envelope such that image capture device 10 is capable of capturing a digital image of at least one side of the check carrier envelope without additional manipulation of the check carrier envelope by employee 12. In a first example, employee 12 may position the check carrier envelope directly on a scanning surface (i.e., an image capture area) of a copier machine as though employee 12 were making an ordinary copy of an ordinary document. In a second example, if image capture device 10 is equipped with an automatic document feeder, employee 12 may position the check carrier envelope in an input tray of the automatic document feeder as though employee 12 were scanning an ordinary document. In this second example, employee 12 may position the check carrier envelope in the input tray of the automatic document feeder by itself or along with other documents and/or check carrier envelopes.

After employee 12 appropriately positions the check carrier envelope, employee 12 may instruct image capture device 10 to initiate an operation that generates a digital image of at least one side of the checks in the check carrier envelope. For example, if image capture device 10 is a copy machine, employee 12 may press a start button of the copy machine. If the operation only generates a digital image of the front side of the checks in the check carrier envelope or a digital image of the rear side of the checks in the check carrier envelope, employee 12 may reposition the check carrier envelope such that image capture device 10 captures a digital image of the other side of the checks in the check carrier envelope during a second operation. In other words, if image capture device 10 is not configured to perform duplex scanning, employee 12 may have to repeat the scanning operation such that both sides of the checks in the check carrier envelope are scanned.

Once image capture device 10 generates a digital image of the front side of the checks in the check carrier envelope and a digital image of the rear side of the checks in the check carrier envelope, the digital images may be transferred directly or indirectly to a processing device 14 that uses the digital images to generate digital versions of the checks. Processing device 14 may be a wide variety of different types of devices. For instance, processing device 14 may be a personal computer, a mainframe computer, a server, a specialized computing device, or another type of computing device that is capable of using the digital images to generate digital versions of the checks. Processing device 14 may be operated by enterprise 4 or another entity. Furthermore, processing device 14 may, in some circumstances, be integrated into image capture device 10. In other circumstances, the functionality of processing device 14 may be divided among two or more separate devices, but are referred to herein as a single processing device for ease of explanation.

After the digital image of the front sides of the checks in the check carrier envelope and the digital image of the rear sides of the checks in the check carrier envelope are transferred to processing device 14, employee 12 may perform a variety of actions with the check carrier envelope and the checks. In a first example, employee 12 could remove the checks from the check carrier envelope and destroy the checks. In this example, employee 12 could then reuse the check envelope. In a second example, the check carrier envelope could include a closure mechanism that permanently or temporarily seals the checks in the check carrier envelope. In this second example, employee 12 may use the closure mechanism to seal the checks in the check carrier envelope before or after image capture device 10 captures the digital images. Furthermore, in this second example, employee 12 may permanently or temporarily archive the sealed check carrier envelope. As described in detail below, the closure mechanism mentioned in this second example may be any of one or more closure mechanisms in a wide variety of closure mechanisms. Such closure mechanisms may include adhesive closures, crimping closures, hook-and-loop closures, static electrical closures, folding closures, and/or other types of closure mechanisms.

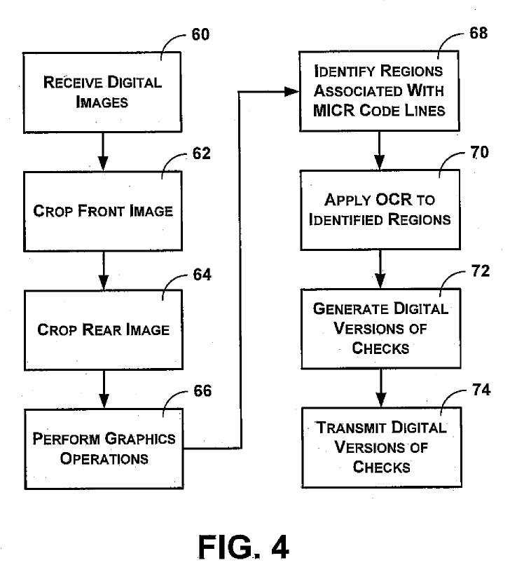

In addition, after the digital image of the front sides of the checks in the check carrier and the digital image of the rear sides of the checks in the check carrier envelope are transferred to processing device 14, processing device 14 may generate a digital version of each of the checks in the check carrier envelope. An example operation by which processing device 14 generates the digital versions of the checks is described in detail below with regard to FIG. 4.

After processing device 14 generates a digital version of a check in the check carrier envelope, processing device 14 may transmit the digital version of the check via a network 16 to a server 18 associated with financial institution 6. Network 16 may include a plurality of devices that communicate via one or more communication links. As such, network 16 may be a local area network (e.g., an Ethernet), a wide area network, a telephone network, a metropolitan area network, a cellular telephone network, a global area network, an internet work (e.g., the Internet), an intranet, an extranet, or another type of network. Communication links between devices within network 16 may be wired communication links and/or wireless communication links. Server 18 may be a computing device operated by financial institution 6 or another entity on behalf of financial institution 6. For example, server 18 may be a device in a server farm operated by financial institution 6 or a third-party data processing organization. Furthermore, the functionality of server 18 may be distributed among two or more devices.

Processing device 14 may transmit the digital version of the check via network 16 to server 18 in a variety of ways. For instance, processing device 14 may send an email to server 18 to which the digital version of the check is attached. In another instance, processing device 14 may send the digital version of the check to server 18 via network 16 using a Hypertext Transfer Protocol (HTTP), a File Transfer Protocol, or another type of network protocol.

When server 18 receives the digital version of the check server 18 may interact via network 16 with a server 20 operated by or for check processing authority 8 to clear the check. In general, the interaction between server 18 and server 20 results in amount of money indicated by the check being electronically transferred to the bank account held by financial institution 6 for enterprise 4. In the United States, the interaction may conform to the Check 21 Act process, the Automated Clearing House (ACH) process, or a Back Office Conversion (BOC) process.

In this way, enterprise 4 is able to generate digital versions of received checks and submit the digital versions of the received checks to financial institution 6 using conventional office equipment. In other words, enterprise 4 is able to generate digital versions of received checks and submit the digital versions of the received checks to financial institution 6 without the need to utilize a special-purpose check scanner.

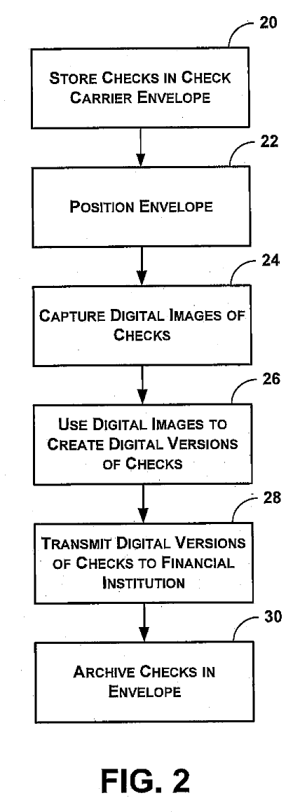

FIG. 2 is a flowchart illustrating an example operation of system 2 (FIG. 1) to image financial documents stored in check carrier envelopes. Initially, employee 12 may insert checks into the pockets of a check carrier envelope (20). After employee 12 inserts the checks into the pockets of the check carrier envelope, employee 12 may position the check carrier envelope in a part of image capture device 10 such that no further manipulation of the envelope by employee 12 is required in order to capture digital images of checks stored in the envelope (22).

Next, image capture device 10 may capture a digital image of the front sides of the checks stored in the check carrier envelope and a digital image of the rear sides of the checks stored in the check carrier envelope (24). Processing device 14 may then use the digital images to create digital versions of the checks stored in the check carrier envelope (26).

Subsequently, processing device 14 may transmit the digital versions of the checks to server 18 at financial institution 6 via network 16 (28). Employee 12 may then archive the checks in the check carrier envelope (30).

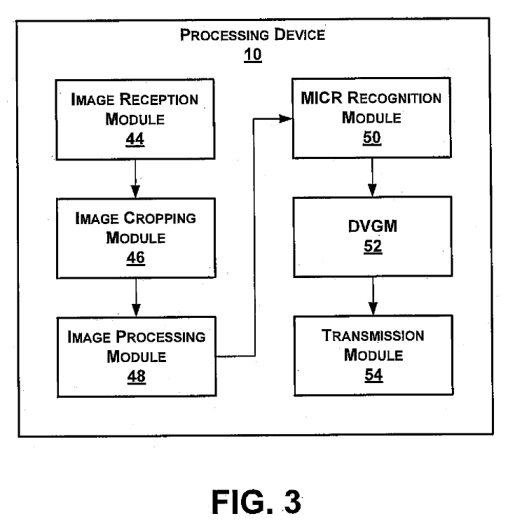

FIG. 3 is a block diagram illustrating example details of processing device 14. As illustrated in the example of FIG. 3, processing device 14 includes a set of “modules.” These modules may comprise hardware units, software units, firmware units, and/or other types of information processing units. For instance, one or more of these modules may be application-specific integrated circuits (ASICs). In another instance, one or more of these modules may be sets of software and/or firmware instructions stored in internal or external read-only memory (RAM), flash memory, random-access memory (RAM), a magnetic storage medium, an optical storage medium, or another type of data storage medium.

As illustrated in the example of FIG. 3, processing device 14 comprises an image reception module 44 that receives a digital image of the front sides of checks stored in a check carrier envelope and a digital image of the rear sides of the checks stored in the check carrier envelope. For ease of explanation, this disclosure refers to the digital image of the front sides of the checks stored in the check carrier envelope as the “front captured image” and refers to the digital image of the rear sides of the checks stored in the check carrier envelope as the “rear captured image.” The front captured image may include images of the front sides of each of the checks. Similarly, the rear captured image may include images of the rear sides of each of the checks. For example, if the check carrier envelope stores three checks, the front captured image contains the images of the front sides of the three checks.

After image reception module 44 receives the front captured image and the rear captured image, an image cropping module 46 may crop the front captured image into separate images of the front sides of the checks and may crop the rear captured image into separate images of the rear sides of the checks. For instance, if the front captured image contains the images of the front sides of three checks, image cropping module 46 may crop the front captured image to generate three separate images, each representing the front side of an individual one of the checks. In this way, if the check carrier envelope stores three checks, image cropping module 46 produces six images: an image of the front side of the first check, an image for the front side of the second check, an image for the front side of the third check, an image for the rear side of the first check, an image for the rear side of the second check, and an image for the rear side of the third check.

An image processing module 48 in processing device 14 may perform one or more graphics operations on the images of the front sides and rear sides of the checks. These graphics operations may include image compression to the International Telegraph and Telephone Consultative Committee (CCITT) Group IV standard at 200 dots per inch. The CCITT Group IV standard at 200 dots per inch conforms to the Check 21 Act. In addition, image processing module 48 may perform a de-skewing operation that reduces skew within the images. In other words, the de-skewing operation attempts to adjust the images of the sides of the checks such that the top and bottom edges of the checks are parallel to the horizontal axis of the image. Image processing module 48 may also perform image cleanup operations and spot removal in order to make the images easier to read.

A MICR recognition module 50 in processing device 14 may identify regions of the images of the front sides of the checks associated with the MICR code lines of the checks. Next, MICR recognition module 50 may apply optical character recognition (OCR) to the identified regions of the images of the front sides of the checks. In this way, MICR recognition module 50 identifies the characters in the MICR lines of the checks. A digital version generation module (DVGM) 52 in processing device 14 uses the images of the front sides of the checks, the images of the rear sides of the checks, and the characters of MICR code lines of the checks to generate digital versions of the checks. As discussed above, a digital version of a check includes a digital image of the front side of the check, a digital image of the rear side of the check, and metadata that specifies the characters in the MICR code line of the check.

A transmission module 54 in processing device 14 may then transmit the digital versions of the checks via network 16 to server 18. For example, transmission module 52 may be a network interface that transmits the digital versions of the checks on network 16. In this way, server 18 at financial institution 6 receives digital versions of each of the checks stored in the check carrier envelope in the same manner as when server 18 receives digital versions of checks that are fed through specialized check scanning equipment.

FIG. 4 is a flowchart illustrating an example operation of processing device 14. As illustrated in the example of FIG. 4, image reception module 44 in processing device 14 receives a digital image of the front sides of checks stored in a check carrier envelope (i.e., the front captured image) and a digital image of the rear sides of the checks stored in the check carrier envelope (i.e., the rear captured image) (60). After image reception module 44 receives the front captured image and the rear captured image, image cropping module 46 may crop the front captured image into separate images of the front sides of the checks (62). Next, image cropping module 46 crops the rear captured image into separate images of the rear sides of the checks (64).

After image cropping module 46 generates the images of the front sides and rear sides of the checks, image processing module 48 may perform one or more graphics operations on the digital images of the front sides of the checks and the digital images of the rear sides of the checks to improve the usefulness of the images (66). Once image processing module 48 performs the graphics operations, the MICR recognition module 50 may identify regions of the images of the front sides of the checks associated with the MICR code lines of the checks (68). Next, MICR recognition module 50 may use optical character recognition (OCR) identify characters within the identified regions of the images of the front sides of the checks (70). In this way, MICR recognition module 50 identifies the characters in the MICR code lines of the checks.

Once MICR recognition module 50 has identified the characters in the MICR code lines of the checks, DVGM 52 uses the digital images of the front sides of the checks, the digital images of the rear sides of the checks, and the characters in the MICR code lines of the checks to generate digital versions of the checks (72). Next, transmission module 54 causes each of the digital versions of the checks to be transmitted via network 16 to server 18 at financial institution 6 (74).

FIG. 5 is an illustration of an example check carrier envelope 90. Check carrier envelope 90 includes a front surface member and a rear surface member. The front surface member and the rear surface member are bonded to one another along edges 102A, 102B, 102C, 102D, 104A, 104B, and 104C, but not along edges 106A, 106B, or 106C. Because the front surface member and the rear surface member are not bonded along edges 106A, 106B, and 106C through 110, checks and other financial documents may be securely inserted between the front surface member and the rear surface member through the openings along edges 106A, 106B, and 106C. Because checks may be inserted between the front surface member and the rear surface member in this manner, the front surface member and the rear surface member define pockets.

In the example of FIG. 5, the rear surface member of check carrier envelope 90 is 8.5 inches wide and 11 inches high. The front surface member of check carrier envelope 90 is 8.25 inches wide and 11 inches high. Consequently, the rear surface member extends 0.25 inches further than the front surface member. The extra 0.25 inches of the rear surface member may allow humans to easily insert checks into the pockets defined by the front surface member and the rear surface member.

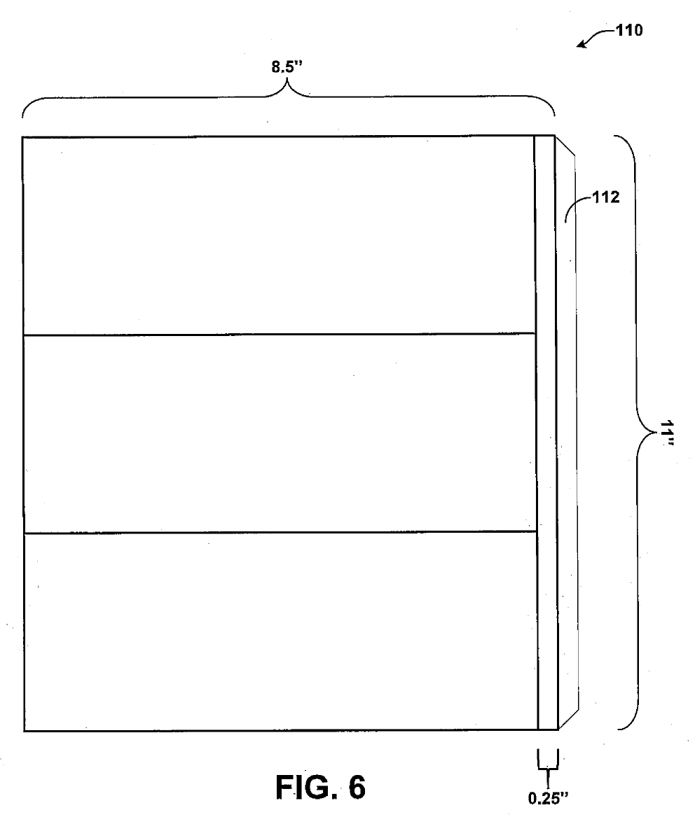

FIG. 6 is an illustration of an example alternate check carrier envelope 110. Like check carrier envelope 90 in the example of FIG. 5, check carrier envelope 110 includes a front surface member and a rear surface member that are bonded to one another along similar edges. However, the rear surface member of check carrier envelope 110 includes a flap 112. Employee 12 may fasten flap 112 to the front surface member using one or more types of closure mechanisms. In a first example, one side of flap 112 may be coated with a permanent or temporary adhesive that is originally covered with a paper strip. In this first example, after employee 12 inserts checks into the pockets of check carrier envelope 110, employee 12 may remove the paper strip and fold flap 112 into contact with the front surface member, thereby permanently or temporarily adhering flap 112 to the front surface member. In a second example, employee 12 may fold flap 112 into contact with the front surface member and then run a crimping device along the edge created by folding flap 112 into contact with the front surface member, thereby creating a permanent closure.

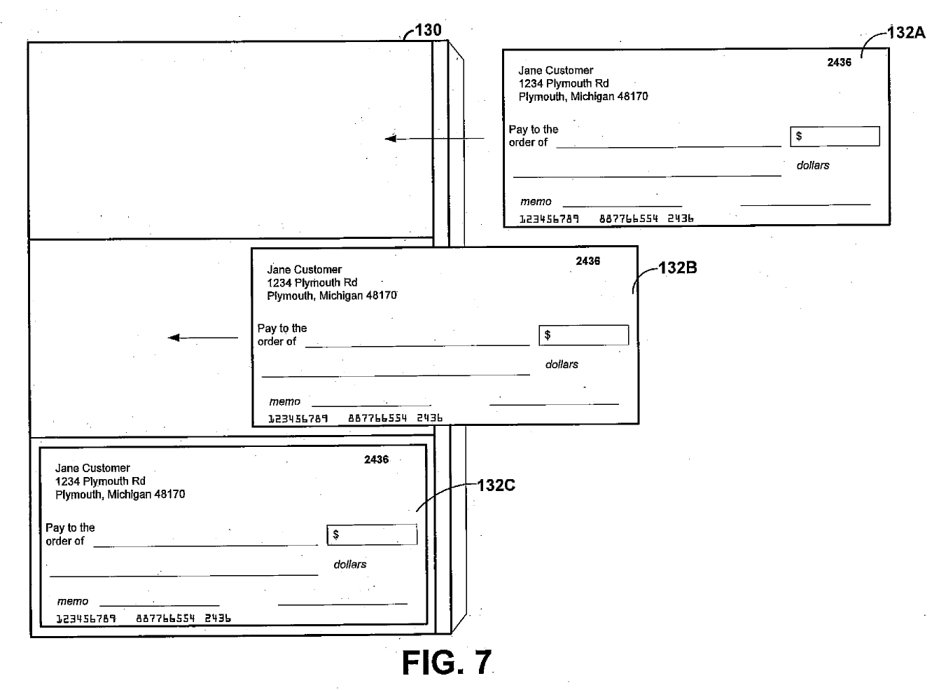

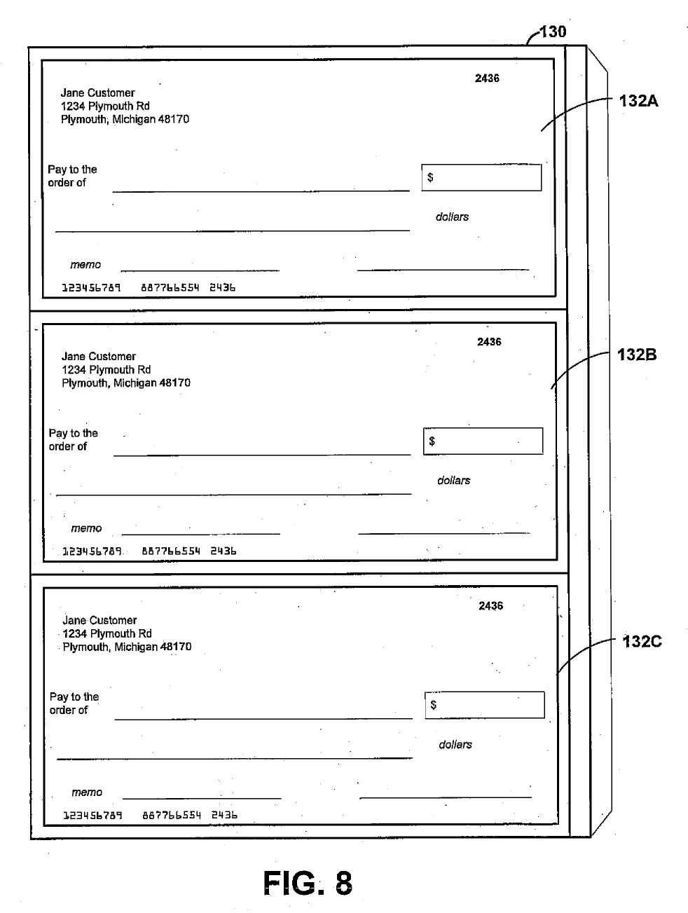

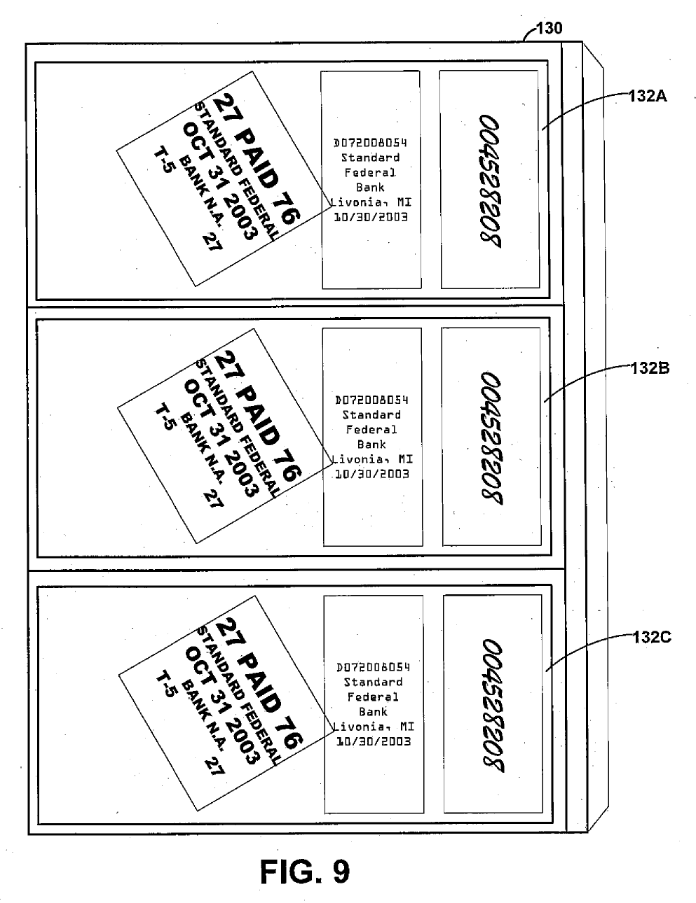

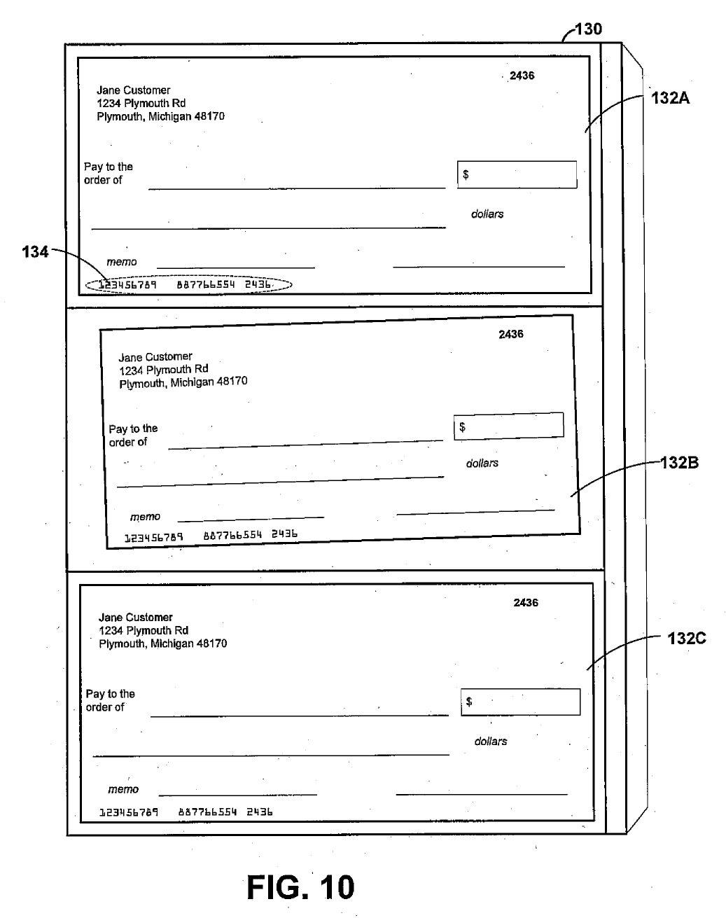

FIG. 7 illustrates how checks may be inserted into a check carrier envelope 130. Check carrier envelope 130 may be similar in construction to check carrier envelope 110 illustrated in the example of FIG. 5. As illustrated in the example of FIG. 7, three standard sized checks 132A, 132B, and 132C (collectively, “checks 132”) may be manually inserted into the side of check carrier envelope 130 from right to left.

FIG. 8 illustrates how a front side of check carrier envelope 130 may appear when check carrier envelope 130 is storing checks 132. As illustrated in the example of FIG. 8, the front sides of checks 132 are clearly visible through the front surface member of check carrier envelope 130.

FIG. 9 illustrates how a rear side of check carrier envelope 130 may appear when check carrier envelope 130 is storing checks 132. As illustrated in the example of FIG. 9, the rear sides of checks 132 are clearly visible through the rear surface member of check carrier envelope 130.

FIG. 10 illustrates how one of checks 132 may be skewed within one of the pockets of check carrier envelope 130. In the example of FIG. 10, check 132B is skewed such that the right side of check 132B is higher than the left side of check 132B. Image processing module 48 in processing device 14 (FIG. 3) may perform a graphics operation that corrects the skew in the image of the front side of check 132B and the image in the rear side of check 132B.

In addition, FIG. 10 illustrates an area 134 of check 132A that contains the MICR code line of check 132A.

Although this disclosure has been explained within the context of checks, the techniques described in this disclosure may be applied to other types of financial documents. For example, the techniques described in this disclosure may be applied to bill remittance slips, stock proxy slips, or other types of financial documents.

Various embodiments of the invention have been described. These and other embodiments are within the scope of the following claims.

1. A method comprising:
positioning an envelope in a part of an image capture device such that no further manipulation of the envelope by a human is required in order to capture a digital image of financial documents stored in the envelope,
wherein the envelope comprises one or more front surface members and one or more rear surface members that are connected to each other such that the front surface members and the rear surface members define one or more pockets that are sized to store one of the financial documents securely,
wherein the envelope is sized such that an automatic document feeding device that is capable of automatically feeding individual pages of a standard paper size through an image capture area of an image capture device is capable of automatically feeding the envelope through the image capture area of the image capture device,
wherein the one or more front surface members of the envelope and the one or more rear surface members of the envelope are sufficiently transparent to enable an image capture device to optically capture digital images of a front surface and a rear surface of each of the financial documents stored in the envelope,
generating digital images of a front surface and a rear surface of each of the financial documents that are stored in the envelope; and
electronically transmitting digital versions of the financial documents to one or more financial institutions, wherein each of the digital versions of the financial documents include the digital images of the front surface of the financial document and the digital image of the rear surface of the financial document.

2. The method of claim 1,
wherein the financial documents are checks; and
wherein the financial institution is a financial institution that uses the digital versions of the checks in an automated check clearing process.

3. The method of claim 1, further comprising automatically feeding the envelope into the image capture area of the image capture device.

4. The method of claim 3,
wherein positioning the envelope comprises positioning the envelope in an input tray of the image capture device along with one or more documents; and
wherein the method further comprises automatically feeding the one or more documents, including the envelope, into the image capture area of the image capture device.

5. The method of claim 4,
wherein the one or more documents include one or more envelopes,
wherein each of the envelopes comprises one or more front surface members and one or more rear surface members that are connected to each other such that the front surface members and the rear surface members define one or more pockets,
wherein each of the one or more pockets are sized to store a financial document securely,
wherein each of the envelopes is sized such that the automatic document feeding device is capable of automatically feeding the envelopes through the image capture area of the image capture device, and
wherein the one or more front surface members and the one or more rear surface members of the envelopes are sufficiently transparent to enable the image capture device to optically capture digital images of a front surface and a rear surface of each of the financial documents stored in the envelopes.

6. The method of claim 1, wherein the standard paper size is selected from a group of standardized paper sizes that consists of: letter (8.5 inches by 11 inches), A4, and legal.

7. The method of claim 1,
wherein the method further comprises analyzing the digital images of the front surfaces of the financial documents to optically identify characters in Magnetic Ink Character Recognition (MICR) code lines of the financial documents; and
wherein electronically transmitting digital versions of the financial documents comprises transmitting metadata that indicates the identified characters in the MICR code lines of the financial documents to the one or more financial institutions.

8. The method of claim 1,
wherein the method further comprises performing one or more graphics operations on the digital images of the front surface and the rear surface of each of the financial documents; and
wherein the graphics operations are selected from a group consisting of an image compression operation, a deskew operation, an image cleanup operation, and a spot removal operation.

9. The method of claim 1, further comprising archiving the financial documents in the envelope.

10. The method of claim 1, wherein the envelope further comprises a closure mechanism that seals the financial documents in the pockets of the envelope.

11. A system comprising:
an image capture device that receives an envelope in a part of the image capture device such that no further manipulation of the envelope by a human is required in order to capture a digital image of financial documents stored in the envelope,
wherein the envelope comprises one or more front surface members and one or more rear surface members that are connected to each other such that the front surface members and the rear surface members define one or more pockets that are sized to store one of the financial documents securely,
wherein the envelope is sized such that an automatic document feeding device that is capable of automatically feeding individual pages of a standard paper size through the image capture area of the image capture device is capable of automatically feeding the envelope through the image capture area of the image capture device,
wherein the one or more front surface members of the envelope and the one or more rear surface members of the envelope are sufficiently transparent to enable the image capture device to optically capture digital images of a front surface and a rear surface of each of the financial documents stored in the envelope; and
a processing device that generates digital images of a front surface and a rear surface of each of the financial documents that are stored in the envelope; and
wherein the processing device comprises a transmission module that electronically transmits digital versions of the financial documents to one or more financial institutions, wherein each of the digital versions of the financial documents include the digital images of the front surface of the financial document and the digital image of the rear surface of the financial document.

12. The system of claim 11,
wherein the financial documents are checks; and
wherein the financial institution is a financial institution that uses the digital versions of the checks in an automated check clearing process.

13. The system of claim 11, wherein the image capture device comprises an automatic document feeder that automatically feeds the envelope into the image capture area of the image capture device.

14. The system of claim 13,
wherein the image capture device comprises an input tray that receives the envelope along with one or more documents; and
wherein the automatic document feeder automatically feeds the one or more documents, including the envelope, into the image capture area of the image capture device.

15. The system of claim 14,
wherein the one or more documents include one or more envelopes,
wherein each of the envelopes comprises one or more front surface members and one or more rear surface members that are connected to each other such that the front surface members and the rear surface members define one or more pockets,
wherein each of the one or more pockets are sized to store a financial document securely,
wherein each of the envelopes is sized such that the automatic document feeding device is capable of automatically feeding the envelopes through the image capture area of the image capture device, and
wherein the one or more front surface members and the one or more rear surface members of the envelopes are sufficiently transparent to enable the image capture device to optically capture digital images of a front surface and a rear surface of each of the financial documents stored in the envelopes.

16. The system of claim 11, wherein the standard paper size is selected from a group of standardized paper sizes that include letter (8.5 inches by 11 inches), A4, and legal.

17. The system of claim 11,
wherein the processing device comprises a Magnetic Ink Character Recognition (MICR) recognition module that analyzes the digital images of the front surfaces of the financial documents to optically identify characters in MICR code lines of the financial documents; and
wherein the transmission module electronically transmits the identified characters in the MICR code lines of the financial documents to the one or more financial institutions.

18. The system of claim 11,
wherein the processing device comprises an image processing module that performs one or more graphics operations on the digital images of the digital images of the front surface and the rear surface of each of the financial documents; and
wherein the graphics operations are selected from a group consisting of: an image compression operation, a deskew operation, an image cleanup operation, and a spot removal operation.

19. The system of claim 1, wherein the envelope comprises a closure mechanism that seals the financial documents in the pockets of the envelope.
